(19) United States
(12) Patent Application Publication
(10) Pub. No.: US 2024/0241955 A1
(43) Pub. Date: Jul. 18, 2024

(54) DATA SECURITY FOR PORTABLE STORAGE MEDIUMS

(71) Applicant: Secturion Systems, Inc., Centerville, UT (US)

(72) Inventors: RICHARD J. TAKAHASHI, LAYTON, UT (US); BENJAMIN KIRK NIELSON, WEST HAVEN, UT (US)

(73) Assignee: Secturion Systems, Inc., Centerville, UT (US)

(21) Appl. No.: 18/406,611

(22) Filed: Jan. 8, 2024

Related U.S. Application Data
(60) Provisional application No. 63/438,889, filed on Jan. 13, 2023.
(60) Provisional application No. 63/460,368, filed on Apr. 19, 2023.

(51) Int. Cl. G06F 21/56; G06F 21/60

(52) U.S. Cl. CPC G06F 21/566; G06F 21/602

(57) ABSTRACT

Apparatus and methods related to securely transmitting data between a portable storage or other medium and a data storage system. In one approach, a portable storage medium drive reads data from a portable storage medium, and a password key decryption unit automatically decrypts the data using a password key in response to having obtained the password key. A storage key encryption unit automatically encrypts the first password key decrypted data using a storage key in response to an availability of the password key decrypted data. A storage interface automatically transmits the storage key encrypted data to the data storage system in response to an availability of the storage key encrypted data.

### RELATED APPLICATIONS

This application claims the benefit, and priority benefit, of U.S. Provisional Patent Application Ser. No. 63/438,889, filed Jan. 13, 2023, entitled “DATA SECURITY FOR PORTABLE STORAGE MEDIUMS,” by Richard J. Takahashi and Benjamin Kirk Nielson. This application also claims the benefit, and priority benefit, of U.S. Provisional Patent Application Ser. No. 63/460,368, filed Apr. 19, 2023, entitled “DATA SECURITY FOR PORTABLE STORAGE MEDIUMS,” by Richard J. Takahashi and Benjamin Kirk Nielson, the disclosure and contents of which are incorporated by reference herein in their entirety.

### FIELD OF THE TECHNOLOGY

At least some embodiments disclosed herein relate to secure data in general, and more particularly, but not limited to securing data transfer from storage mediums.

### BACKGROUND

### Brief Description of the Drawings

The embodiments are illustrated by way of example and not limitation in the figures of the accompanying drawings in which like references indicate similar elements.

FIG. 1 shows a secure data encryptor (SDE) disposed in a computing system in accordance with some embodiments.

FIG. 2 is a block diagram illustrating an implementation of the SDE in accordance with some embodiments.

FIG. 3 shows the SDE coupled to multiple local storage systems and/or multiple cloud storage systems simultaneously in accordance with some embodiments.

FIG. 4 is a flowchart illustrating an operation of the SDE in accordance with some embodiments.

### DETAILED DESCRIPTION

At least some embodiments in the following disclosure describe securing data transfer from portable storage mediums, such as for example a CD, DVD, data drive and/or storage device. At least some embodiments relate to employing a separate secure data encryptor to read data from and/or write data to such portable storage mediums.

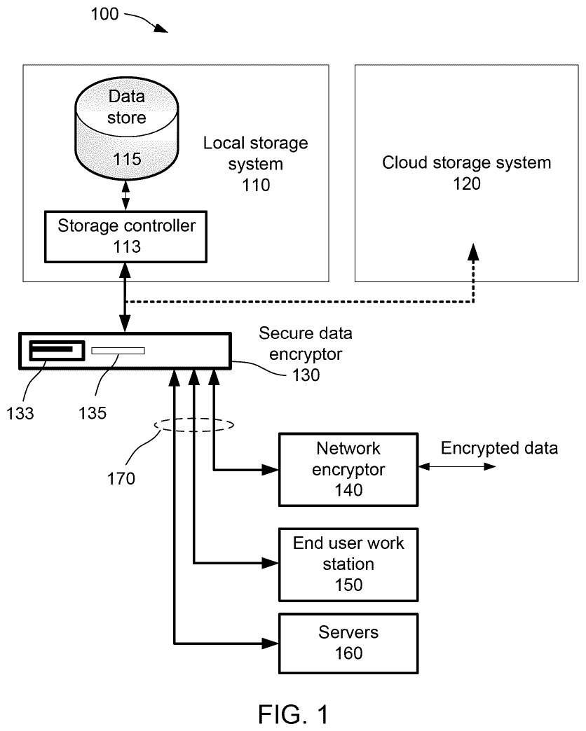

FIG. 1 shows secure data encryptor 130 included in a computing system 100 in accordance with some embodiments. The secure data encryptor (SDE) 130 is configured to convey encrypted data to and from a local storage system 110 through, for example, a storage controller 113. The SDE 130 is configured to read from and/or write to portable storage mediums, such as for example, CDs, DVDs, data drives, storage devices and host bus adapters (HBAs). The SDE 130 can perform one or more of secure password entry, data filtering, validation-authentication, virus scanning, audit logging, user authentication and/or encryption.

Local storage system 110 includes, for example, a data store 115.

In one example, SDE 130 includes DVD, SSD, CD drive 133 and/or host bus adaptor (HBA) 135. For example, a DVD is read by DVD drive 133.

In some embodiments, the SDE 130 is removably connected to the storage controller 113 through an Ethernet connection. The SDE 130 can also convey encrypted data to and from a cloud storage system 120. In this case, the SDE 130 communicates with the cloud storage system 120 through, for example, a secure Internet or other network connection.

As shown in FIG. 1, the SDE 130 is also removably coupled, exemplarily, to a network encryptor 140, an end user work station 150 (or other end user device), and/or server(s) 160, so that the secure data encryptor 130 can also process data sent to and/or received from these connected devices.

The network encryptor 140 receives encrypted data from an external network, decrypts the data and then sends the data to the SDE 130. The SDE 130 encrypts the data using a storage key before sending the data either to the local storage system 110 or the cloud storage system 120, or both depending on a user's instruction (e.g., entered via a GUI).

The end user work station 150 and the server(s) 160 access (e.g., read and write) the local storage system 110 or the cloud storage system 120 via the SDE 130. The SDE 130 performs secure password entry, data filtering, validation-authentication, virus scanning, audit logging, user authentication and/or encryption.

A connection 170 between the SDE and any of the exemplary network encryptor 140, end user work station 150 and/or servers 160 can be implemented, for example, using either an Ethernet or a transport layer security (TLS) connection or both.

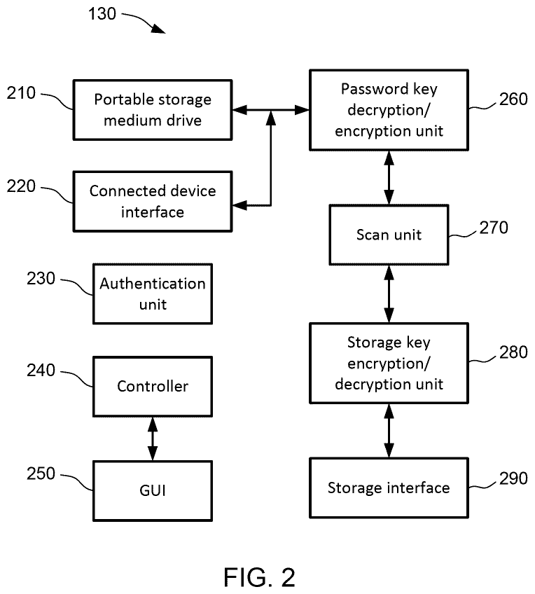

FIG. 2 is a block diagram illustrating an exemplary implementation of the SDE 130 in accordance with some embodiments. The SDE 130 includes a portable storage medium drive 210, a connected device interface 220, a password key decryption/encryption unit 260, a scan unit 270, a storage key encryption/decryption unit 280, a storage interface 290, an authentication unit 230, a controller 240 and a graphical user interface (GUI) 250.

The portable storage medium drive 210 is configured to read from and write data to a portable storage medium, such as for example a CD, DVD, data drive, storage device and/or host bus adapter (HBA), under the control of the controller 240 (e.g., by software executing on a processing device).

The data in the portable storage medium may be encrypted by a password key. When read from the portable storage medium drive 210, the encrypted data is decrypted by the password key decryption/encryption unit 260 using the password key, and then scanned and filtered by the scan unit 270 for malware, viruses, and/or any other security violation.

The password key may, for example, be entered into the SDE 130 by a user through the GUI 250, which provides an interface for handling of read and write commands. For example, the GUI 250 may contain a read button or other icon. Once clicked, a read operation may be started. Similarly, the GUI 250 may contain a write button or other icon for initiating a write operation. The password key may also, for example, be entered into the SDE 130 in a form of biometric parameters, such as fingerprint or face recognition through the GUI 250. In one embodiment, the password key may additionally be issued from a digital key management system, such as described in U.S. Pat. No. 8,295,492, which is hereby incorporated by reference in its entirety.

Referring again to FIG. 2, the scanned data is then encrypted by the storage key encryption/decryption unit 280 using a storage key before being transmitted to the storage system 110 or 120 via the storage interface 290.

In one embodiment, the storage key is generated by the SDE 130 and shared with the storage system 110 and/or 120. In another embodiment, the storage key is obtained from the storage systems 110 and/or 120 once the SDE 130 is coupled thereto. In both embodiments, the storage key is persistently stored in a non-volatile memory in the SDE 130 as long as the associated data need to be accessed.

The scan unit 270 and the storage key encryption/decryption unit 280 operate automatically without a user's involvement once data needing to be processed becomes available. With automatic scanning and encryption/decryption, the SDE 130 becomes a utility device that saves a user from manually performing such operations. The storage keys represent the owner of the stored data. These storage keys can either be generated by the SDE on user request (e.g., an explicit or implicit request by other user action), or imported to the SDE from a digital key management system.

Referring again to FIG. 2, the authentication unit 230 is configured to authenticate a user interfacing with the SDE 130. In one embodiment, once the user inserts a portal storage medium into the portable storage medium drive 210, the GUI 250 will prompt the user to enter a password (e.g., log-in to a previously-established account). The scan unit 270 and the storage key encryption/decryption unit 280 operate automatically without a user's involvement once data needing to be processed becomes available. With the automatic scanning and encryption/decryption, the SDE 130 becomes a utility device that saves a user from manually performing such operations. A user transfer request from the SDE to a portable storage medium or from a portable storage medium to the SDE will trigger a decryption-scan-report-log-and-encryption sequence to either import or export data with regard to the SDE.

In one example, during the log-in, for a given user name, the authentication unit 230 sends a verification code to a personal computing device, such as a mobile device (e.g., smartphone), of the user. Then, the user enters the verification code on the GUI 250 to log-in to the established account. In one example, the established account has an associated password key stored in a non-volatile memory in the SDE 130, so that the user does not need to re-enter the password each time when accessing the SDE 130.

In one embodiment, each unit of data stored in the storage system 110 corresponds to a storage key.

When data is received from the storage system 110 or 120 via the storage interface 290, the data is first decrypted by the storage key encryption/decryption unit 280 using the corresponding storage key, and then encrypted by the password key decryption/encryption unit 260 using a password key (e.g., in response to the instruction of a user of the SDE 130). In one example, the password key is entered by a user through the GUI 250 and may not be persistent in the SDE 130.

Referring again to FIG. 2, the connected device interface 220 is configured to communicate with connected devices, such as the network encryptor 140, the end user work station 150 and/or the servers 160. In one embodiment, data transmitted between the connected devices and the storage system 110 or 120 also goes through the password key decryption or encryption and storage key encryption or decryption processes described above. In one embodiment, a data storage unit can be a logical unit number (LUN), a partition, or a shared directory depending on the granularity of data ownership allowed by the protocol used to access it. For iSCSI this would be per LUN. Each LUN would be a single ownership domain, and a single key would be used to securely access it. For NFS this would be a single shared directory and all contents recursively. For NVMe-oF each namespace would be a storage unit (e.g., a volume).

In some embodiments, system feedback information may be displayed on the GUI 250. For example, the SDE 130 reads data from a CD or SSD. After authentication, the SDE 130 sends the encrypted data to the storage controller 113 for writing into the storage system 110. Once the writing is completed, the GUI 250 displays an acknowledgement that the encrypted data has been written into the storage system 110.

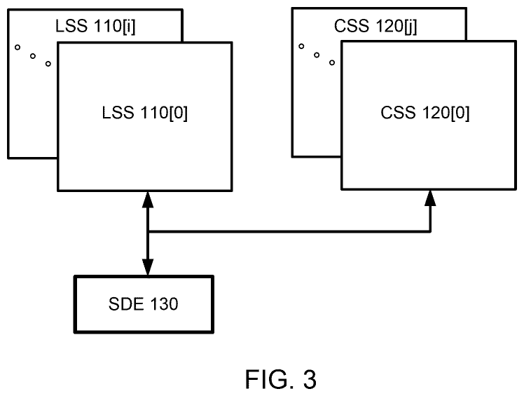

FIG. 3 shows the SDE 130 coupled to multiple local storage systems (LSS) and/or multiple cloud storage systems (CSS) simultaneously in accordance with some embodiments. As an example, there are i+1 number of local storage systems (110[0:i]), where i is an integer, coupled to the SDE 130 simultaneously; and there are j+1 number of cloud storage systems (120[0:j]), where j is an integer, coupled to the SDE 130 simultaneously.

In one embodiment, the SDE 130 manages data access to individual LSS 110 [0:i] and CSS 120[0:j] as described above. In one embodiment, each LSS and CSS provides a storage key unique to particular unit of data to the SDE 130 for encrypting and decrypting the data to be stored in the respective LSS and CSS.

The unique storage key is stored in the SDE 130 and can be retrieved with an identification of the corresponding LSS or CSS. For example, certain bits of a storage key may be defined to represent an identification of a particular LSS or CSS. By reading out these bits, a corresponding LSS or CSS can be quickly identified.

In one embodiment, an individual LSS 110 or CSS 120 may provide multiple storage keys to the SDE 130 for encrypting and decrypting data to be stored in different sections of the LSS 110 or CSS 120. Each of these storage keys is stored in the SDE 130 and can be retrieved with an identification of a corresponding section of a LSS 110 or CSS 120.

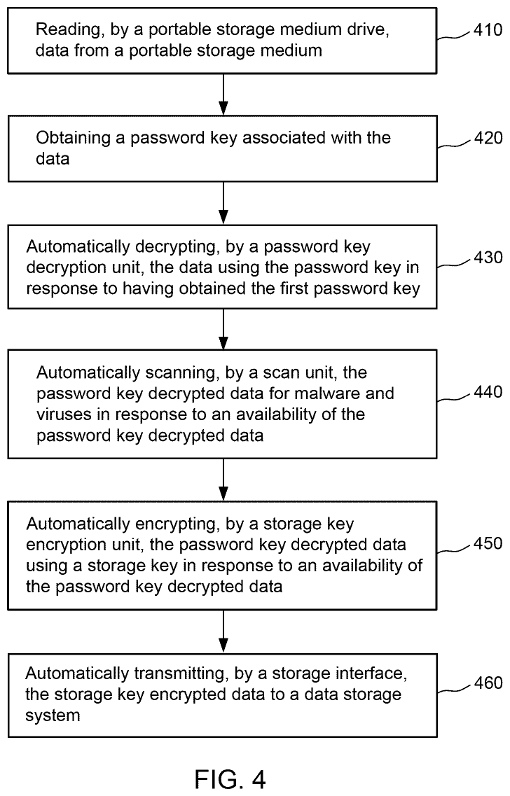

FIG. 4 is a flowchart illustrating an operation of the SDE 130 in accordance with some embodiments. The operation begins with reading, by a portable storage medium drive 210, data from a portable storage medium in block 410. The SDE 130 then obtains a password key associated with the data in block 420.

In other embodiments, data can be read using other types of hardware readers. Alternatively, the data may be read from the network encryptor 140. The SDE 130 is capable of generating, exporting, and importing new keys for use as data unit encryption keys, or data export keys. When a new data unit has been requested, either explicitly or implied in operations, the operations include the SDE 130 generating a new key.

The SDE 130 decrypts the received encrypted data using a key from the network encryptor 140 and then encrypts the decrypted data using a storage key as described above. In one embodiment, an individual LSS 110 or CSS 120 may provide multiple storage keys to the SDE 130 for encrypting and decrypting data to be stored in different sections of the LSS 110 or CSS 120. Each of these storage keys is stored in the SDE 130 and can be retrieved with an identification of a corresponding section of a LSS 110 or CSS 120. Each section is labeled with a hash of the corresponding key. Performing the hash on the key identifies which key corresponds to which section.

In block 430, the SDE 130 automatically decrypts, by the password key decryption unit 260, the data using the password key in response to having obtained the password key. The decryption process is automatically initiated without pending an instruction from a user of the SDE 130.

In block 440, the SDE 130 automatically scans, by the scan unit 270, the password key decrypted data for malware and viruses in response to an availability of the password key decrypted data.

In block 450, the SDE 130 automatically encrypts, by a storage key encryption unit 280, the password key decrypted data using a storage key in response to an availability of the password key decrypted data.

In block 460, the SDE 130 automatically transmits, by a storage interface, the storage key encrypted data to the data storage system 110 or 120.

With the aforementioned automatic processes, once the SDE 130 obtains a password key, the data from the portable storage medium will be password key decrypted, scanned, storage key encrypted and transmitted to the storage system 110 or 120 on the SDE 130 itself without involvement of a user of the SDE 130.

In one embodiment, the secure data encryptor 130 can be implemented using encryptors (e.g., a data at rest encryptor (DARE)) as described in U.S. application Ser. No. 17/853,780, filed Jun. 29, 2022, titled “SECURE DATA TRANSFER OVER WIRELESS NETWORKS USING DATA STORAGE ENCRYPTORS”, by Richard J. Takahashi, which is hereby incorporated by reference in its entirety.

In one embodiment, data is obtained by a secure data encryptor (SDE) 130 via a USB physical media inserted into a USB drive (e.g., USB drive 326 of the DARE described in U.S. application Ser. No. 17/853,780).

In some embodiments, data may be obtained wirelessly (e.g., by near-field communication (NFC)).

In one embodiment, an apparatus for removably coupling to a data storage system comprises: a portable storage medium drive configured to read data from a portable storage medium; a decryption unit configured to automatically decrypt the data using a first password key in response to having obtained the first password key; an encryption unit configured to automatically encrypt the first password key decrypted data using a storage key in response to an availability of the first password key decrypted data; and a storage interface configured to automatically transmit the storage key encrypted data to the data storage system in response to an availability of the storage key encrypted data.

In one embodiment, the portable storage medium is a CD, DVD, data drive or storage device.

In one embodiment, the apparatus further comprises an authentication unit configured to authenticate an account by sending a verification code to a personal device of a user of the account.

In one embodiment, the apparatus further comprises memory, wherein the first password key is stored in the memory, the first password key is associated with a first account, and the first password key is retrieved after an authentication of the first account.

In one embodiment, the storage key is obtained from the data storage system.

In one embodiment, the apparatus further comprises a scan unit configured to automatically scan the first password key decrypted data for malware and viruses in response to an availability of the first password key decrypted data.

In one embodiment, the scanning is performed before the encrypting by the storage key encryption unit.

In one embodiment, the apparatus further comprises a graphical user interface configured to receive the first password key.

In one embodiment, the data storage system is coupled to the apparatus by a cable.

In one embodiment, the data storage system is coupled to the apparatus by a network (e.g., the Internet, a wide area network, and/or a local area network).

In one embodiment, the decryption unit is a first decryption unit, and the apparatus further comprises a second decryption unit configured to decrypt data received from the data storage system using the storage key.

In one embodiment, the encryption unit is a first encryption unit, and the apparatus further comprises a second encryption unit configured to encrypt storage key decrypted data using a second password key and provide the second password key encrypted data to the portable storage medium drive.

In one embodiment, a method for securely transmitting data between a portable storage medium and a data storage system comprises: reading, by a portable storage medium drive, data from a portable storage medium; obtaining a first password key associated with the data; automatically decrypting, by a decryptor, the data using the first password key in response to having obtained the first password key; automatically encrypting, by an encryptor, the first password key decrypted data using a storage key in response to an availability of the first password key decrypted data; and automatically transmitting, by a storage interface, the storage key encrypted data to the data storage system (e.g., in response to receiving and/or an availability of the storage key encrypted data).

In one embodiment, the method further comprises authenticating, by an authenticator, an account of a user by sending a verification code to a personal device of the user.

In one embodiment, the obtaining the first password key includes retrieving the first password key from a memory after a first account associated with the first password key is authenticated.

In one embodiment, the method further comprises obtaining the storage key from the data storage system.

In one embodiment, the method further comprises automatically scanning, by a scanner, the first password key decrypted data for malware and viruses in response to an availability of the first password key decrypted data.

In one embodiment, the decryptor is a first decryptor, and the method further comprises decrypting, by a second decryptor, data received from the data storage system using the storage key.

In one embodiment, the encryptor is a first encryptor, and the method further comprises: encrypting, by a second encryptor, the storage key decrypted data using a second password key; and writing, by the portable storage medium drive, the second password key encrypted data to the portable storage medium.

In one embodiment, an apparatus comprises: a component to receive data (e.g., a portable storage medium drive configured to read data from a portable storage medium, or a network interface card (NIC)); a decryption unit (e.g., a unit using a password key) configured to automatically decrypt the received data using a first key (e.g., received from a user via a GUI); a scanner configured to automatically scan the first key decrypted data for malware and viruses (e.g., in response to an availability of the password key decrypted data); an encryption unit configured to automatically encrypt the scanned data using a second key (e.g., using a storage key in response to an availability of the scanned data); and a storage interface configured to automatically transmit the second key encrypted data to a data storage system (e.g., in response to an availability of the storage key encrypted data).

The disclosure includes various devices which perform the methods and implement the systems described above, including data processing systems which perform these methods, and computer-readable media containing instructions which when executed on data processing systems cause the systems to perform these methods.

The description and drawings are illustrative and are not to be construed as limiting. Numerous specific details are described to provide a thorough understanding. However, in certain instances, well-known or conventional details are not described in order to avoid obscuring the description. References to one or an embodiment in the present disclosure are not necessarily references to the same embodiment; and, such references mean at least one.

As used herein, “coupled to” or “coupled with” generally refers to a connection between components, which can be an indirect communicative connection or direct communicative connection (e.g., without intervening components), whether wired or wireless, including connections such as electrical, optical, magnetic, etc.

Reference in this specification to “one embodiment” or “an embodiment” means that a particular feature, structure, or characteristic described in connection with the embodiment is included in at least one embodiment of the disclosure. The appearances of the phrase “in one embodiment” in various places in the specification are not necessarily all referring to the same embodiment, nor are separate or alternative embodiments mutually exclusive of other embodiments. Moreover, various features are described which may be exhibited by some embodiments and not by others. Similarly, various requirements are described which may be requirements for some embodiments but not other embodiments.

In this description, various functions and/or operations may be described as being performed by or caused by software code to simplify description. However, those skilled in the art will recognize what is meant by such expressions is that the functions and/or operations result from execution of the code by one or more processing devices, such as a microprocessor, Application-Specific Integrated Circuit (ASIC), graphics processor, and/or a Field-Programmable Gate Array (FPGA). Alternatively, or in combination, the functions and operations can be implemented using special purpose circuitry (e.g., logic circuitry), with or without software instructions. Embodiments can be implemented using hardwired circuitry without software instructions, or in combination with software instructions. Thus, the techniques are not limited to any specific combination of hardware circuitry and software, nor to any particular source for the instructions executed by a computing device.

While some embodiments can be implemented in fully functioning computers and computer systems, various embodiments are capable of being distributed as a computing product in a variety of forms and are capable of being applied regardless of the particular type of computer-readable medium used to actually effect the distribution.

At least some aspects disclosed can be embodied, at least in part, in software. That is, the techniques may be carried out in a computing device or other system in response to its processing device, such as a microprocessor, executing sequences of instructions contained in a memory, such as ROM, volatile RAM, non-volatile memory, cache or a remote storage device.

Routines executed to implement the embodiments may be implemented as part of an operating system, middleware, service delivery platform, SDK (Software Development Kit) component, web services, or other specific application, component, program, object, module or sequence of instructions (sometimes referred to as computer programs). Invocation interfaces to these routines can be exposed to a software development community as an API (Application Programming Interface). The computer programs typically comprise one or more instructions set at various times in various memory and storage devices in a computer, and that, when read and executed by one or more processors in a computer, cause the computer to perform operations necessary to execute elements involving the various aspects.

A computer-readable medium can be used to store software and data which when executed by a computing device causes the device to perform various methods. The executable software and data may be stored in various places including, for example, ROM, volatile RAM, non-volatile memory and/or cache. Portions of this software and/or data may be stored in any one of these storage devices. Further, the data and instructions can be obtained from centralized servers or peer to peer networks. Different portions of the data and instructions can be obtained from different centralized servers and/or peer to peer networks at different times and in different communication sessions or in a same communication session. The data and instructions can be obtained in entirety prior to the execution of the applications. Alternatively, portions of the data and instructions can be obtained dynamically, just in time, when needed for execution. Thus, it is not required that the data and instructions be on a computer-readable medium in entirety at a particular instance of time.

Examples of computer-readable media include, but are not limited to, recordable and non-recordable type media such as volatile and non-volatile memory devices, read only memory (ROM), random access memory (RAM), flash memory devices, solid-state drive storage media, removable disks, magnetic disk storage media, optical storage media (e.g., Compact Disk Read-Only Memory (CD ROMs), Digital Versatile Disks (DVDs), etc.), among others. The computer-readable media may store the instructions. Other examples of computer-readable media include, but are not limited to, non-volatile embedded devices using NOR flash or NAND flash architectures. Media used in these architectures may include un-managed NAND devices and/or managed NAND devices, including, for example, eMMC, SD, CF, UFS, and SSD.

In general, a non-transitory computer-readable medium includes any mechanism that provides (e.g., stores) information in a form accessible by a computing device (e.g., a computer, mobile device, network device, personal digital assistant, manufacturing tool having a controller, any device with a set of one or more processors, etc.). A “computer-readable medium” as used herein may include a single medium or multiple media (e.g., that store one or more sets of instructions).

In various embodiments, hardwired circuitry may be used in combination with software and firmware instructions to implement the techniques. Thus, the techniques are neither limited to any specific combination of hardware circuitry and software nor to any particular source for the instructions executed by a computing device.

Various embodiments set forth herein can be implemented using a wide variety of different types of computing devices. As used herein, examples of a “computing device” include, but are not limited to, a server, a centralized computing platform, a system of multiple computing processors and/or components, a mobile device, a user terminal, a vehicle, a personal communications device, a wearable digital device, an electronic kiosk, a general purpose computer, an electronic document reader, a tablet, a laptop computer, a smartphone, a digital camera, a residential domestic appliance, a television, or a digital music player. Additional examples of computing devices include devices that are part of what is called “the internet of things” (IOT). Such “things” may have occasional interactions with their owners or administrators, who may monitor the things or modify settings on these things. In some cases, such owners or administrators play the role of users with respect to the “thing” devices. In some examples, the primary mobile device (e.g., an Apple iPhone) of a user may be an administrator server with respect to a paired “thing” device that is worn by the user (e.g., an Apple watch).

In some embodiments, the computing device can be a computer or host system, which is implemented, for example, as a desktop computer, laptop computer, network server, mobile device, or other computing device that includes a memory and a processing device. The host system can include or be coupled to a memory sub-system so that the host system can read data from or write data to the memory sub-system. The host system can be coupled to the memory sub-system via a physical host interface. In general, the host system can access multiple memory sub-systems via a same communication connection, multiple separate communication connections, and/or a combination of communication connections.

In some embodiments, the computing device is a system including one or more processing devices. Examples of the processing device can include a microcontroller, a central processing unit (CPU), special purpose logic circuitry (e.g., a field programmable gate array (FPGA), an application specific integrated circuit (ASIC), etc.), a system on a chip (SoC), or another suitable processor.

In one example, a computing device is a controller of a memory system. The controller includes a processing device and memory containing instructions executed by the processing device to control various operations of the memory system.

All or part of any hardware element disclosed herein may readily be provided in a system-on-a-chip (SoC), including a central processing unit (CPU) package. An SoC represents an integrated circuit (IC) that integrates components of a computer or other electronic system into a single chip. The SoC may contain digital, analog, mixed-signal, and radio frequency functions, all of which may be provided on a single chip substrate. Other embodiments may include a multi-chip-module (MCM), with a plurality of chips located within a single electronic package and configured to interact closely with each other through the electronic package. In various other embodiments, the computing functionalities disclosed herein may be implemented in one or more silicon cores in Application Specific Integrated Circuits (ASICs), Field Programmable Gate Arrays (FPGAs), and other semiconductor chips.

Examples of processing devices include a traditional microprocessor (such as Intel's x86 and x64 architectures), but also matrix processors, graphics processors, and any ASIC, FPGA, microcontroller, digital signal processor (DSP), programmable logic device, programmable logic array (PLA), microcode, instruction set, emulated or virtual machine processor, or any similar “Turing-complete” device, combination of devices, or logic elements (hardware or software) that permit the execution of instructions.

In one example, any number of systems (e.g., the SDE 130) or circuits illustrated in the figures may be implemented on a board of an associated electronic device. The board can be a general circuit board that can hold various components of the internal electronic system of the electronic device and, further, provide connectors for other peripherals. More specifically, the board can provide the electrical connections by which the other components of the system can communicate electrically. Any suitable processor and memory can be suitably coupled to the board based on particular configuration needs, processing demands, and computing designs. Other components such as external storage, additional sensors, controllers for audio/video display, and peripheral devices may be attached to the board as plug-in cards, via cables, or integrated into the board itself. In another example, the electrical circuits of the figured may be implemented as stand-alone modules (e.g., a device with associated components and circuitry configured to perform a specific application or function) or implemented as plug-in modules into application specific hardware of electronic devices.

Although some of the drawings illustrate a number of operations in a particular order, operations which are not order dependent may be reordered and other operations may be combined or broken out. While some reordering or other groupings are specifically mentioned, others will be apparent to those of ordinary skill in the art and so do not present an exhaustive list of alternatives. Moreover, it should be recognized that the stages could be implemented in hardware, firmware, software or any combination thereof.

In the foregoing specification, the disclosure has been described with reference to specific exemplary embodiments thereof. It will be evident that various modifications may be made thereto without departing from the broader spirit and scope as set forth in the following claims. The specification and drawings are, accordingly, to be regarded in an illustrative sense rather than a restrictive sense.

What is claimed is:

1. An apparatus for removably coupling to a data storage system, the apparatus comprising:
a portable storage medium drive configured to read data from a portable storage medium;
a decryption unit configured to automatically decrypt the data using a first password key in response to having obtained the first password key;
an encryption unit configured to automatically encrypt the first password key decrypted data using a storage key in response to an availability of the first password key decrypted data; and
a storage interface configured to automatically transmit the storage key encrypted data to the data storage system in response to an availability of the storage key encrypted data.

2. The apparatus of claim 1, wherein the portable storage medium is a CD, DVD, data drive or storage device.

3. The apparatus of claim 1, further comprising an authentication unit configured to authenticate an account by sending a verification code to a personal device of a user of the account.

4. The apparatus of claim 3, further comprising memory, wherein the first password key is stored in the memory, the first password key is associated with a first account, and the first password key is retrieved after an authentication of the first account.

5. The apparatus of claim 1, wherein the storage key is obtained from the data storage system.

6. The apparatus of claim 1, further comprising a scan unit configured to automatically scan the first password key decrypted data for malware and viruses in response to an availability of the first password key decrypted data.

7. The apparatus of claim 6, wherein the scanning is performed before the encrypting by the storage key encryption unit.

8. The apparatus of claim 1, further comprising a graphical user interface configured to receive the first password key.

9. The apparatus of claim 1, wherein the data storage system is coupled to the apparatus by a cable.

10. The apparatus of claim 1, wherein the data storage system is coupled to the apparatus by a network.

11. The apparatus of claim 1, wherein the decryption unit is a first decryption unit, the apparatus further comprising a second decryption unit configured to decrypt data received from the data storage system using the storage key.

12. The apparatus of claim 11, wherein the encryption unit is a first encryption unit, the apparatus further comprising a second encryption unit configured to encrypt storage key decrypted data using a second password key and provide the second password key encrypted data to the portable storage medium drive.

13. A method for securely transmitting data between a portable storage medium and a data storage system, the method comprising:
reading, by a portable storage medium drive, data from a portable storage medium;
obtaining a first password key associated with the data;
automatically decrypting, by a decryptor, the data using the first password key in response to having obtained the first password key;
automatically encrypting, by an encryptor, the first password key decrypted data using a storage key in response to an availability of the first password key decrypted data; and
automatically transmitting, by a storage interface, the storage key encrypted data to the data storage system.

14. The method of claim 13, further comprising authenticating, by an authenticator, an account of a user by sending a verification code to a personal device of the user.

15. The method of claim 14, wherein the obtaining the first password key includes retrieving the first password key from a memory after a first account associated with the first password key is authenticated.

16. The method of claim 13, further comprising obtaining the storage key from the data storage system.

17. The method of claim 13, further comprising automatically scanning, by a scanner, the first password key decrypted data for malware and viruses in response to an availability of the first password key decrypted data.

18. The method of claim 13, wherein the decryptor is a first decryptor, the method further comprising decrypting, by a second decryptor, data received from the data storage system using the storage key.

19. The method of claim 18, wherein the encryptor is a first encryptor, the method further comprising:
encrypting, by a second encryptor, the storage key decrypted data using a second password key; and
writing, by the portable storage medium drive, the second password key encrypted data to the portable storage medium.

20. An apparatus comprising:
a component to receive data;
a decryption unit configured to automatically decrypt the received data using a first key;
a scanner configured to automatically scan the first key decrypted data for malware and viruses;
an encryption unit configured to automatically encrypt the scanned data using a second key; and
a storage interface configured to automatically transmit the second key encrypted data to a data storage system.
